(19) United States
(12) Patent Application Publication
(10) Pub. No.: US 2005/0272620 A1
(43) Pub. Date: Dec. 8, 2005

(54) Fabric care article with improved scent identification

(76) Inventors: Elise Tomsik Edelman, Cincinnati, OH (US); Mary Ellen Raleigh, Mason, OH (US); Susan Tyler Ede, Cincinnati, OH (US); Marty Allen Vanderstelt, Cincinnati, OH (US); Thomas Jackson Kirk, Cincinnati, OH (US); Gayle Marie Frankenbach, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/197,039

(22) Filed: Aug. 4, 2005

Related U.S. Application Data
(63) Continuation of application No. 11/059,099, filed on Feb. 16, 2005.
(60) Provisional application No. 60/554,692, filed on Mar. 19, 2004.

(51) Int. Cl. C11D 3/50

(52) U.S. Cl. 510/101

(57) ABSTRACT

Fabric care articles with scent identifiers and education scent elements provide users with an improved scent experience.

### CROSS REFERENCE

This application is a continuation of U.S. patent application Ser. No. 11/059,099, filed Feb. 16, 2005, which claims the benefit of U.S. Provisional Application No. 60/554,692 filed Mar. 19, 2004, incorporated herein by reference.

### FIELD OF THE INVENTION

The present invention relates to fabric care articles comprising a fabric care composition with an improved scent experience.

### BACKGROUND OF THE INVENTION

Articles comprising fabric care compositions are well known in the art. Fabric care compositions comprising perfumes are also well known in the art. However, there is a continuing need for articles containing fabric care composition with perfume to communicate more clearly to the user the scent experience of using the composition. The scent of a fabric care composition plays an important role in a consumer's purchase decision. Since the consumer will live intimately with the fabric (i.e., wear it), the scent experience becomes of primary importance.

Considering the weight the scent experience plays in the consumer's decision to purchase or not, many consumers have a strong desire to “sample” the scent experience before, or preferably at the point of purchase. For many consumers, “sampling” takes the form of opening the package at the point of purchase to “sample” the scent experience. Consumers may hesitate to open the package due to messiness (spillage), inhibition (store employees may observe the behavior and react negatively), difficulty (impossible to open easily without being observed, package is sealed and opening would be obvious), obligation (once opened the consumer feels obligated to buy), or sanitary considerations (the product would become contaminated). Some consumers will overcome these barriers to open the packaging and “sample” the scent experience in spite of the barriers, but removing the barriers to making a knowledgeable and comfortable decision about the desirability of the products “scent experience” would improve the likelihood that the consumer would find the right scent experience and make a positive purchase decision.

Therefore there is a continuing need to provide consumers a positive scent experience and allow the consumers to find the right scent experience for them.

### SUMMARY OF THE INVENTION

The present invention attempts to address this need by providing an article comprising an article comprising: a rinse-added fabric conditioning composition comprising a perfume; a container releasably containing the composition; at least one label attached to the container; two or three natural scent identifiers located on the label; a visual scent descriptor located on said at least one label visually describing the two scent identifiers; a narrative scent descriptor comprising at least five words located on said at least one label.

The present invention also provides methods of using the article as well as kits containing the article.

### DETAILED DESCRIPTOR OF THE INVENTION

I. Fabric Care Composition Comprising Perfume

One aspect of the invention provides a fabric care composition comprising a perfume.

The term “perfume” is used herein the broadest sense to include any substance that diffuses or imparts an agreeable or attractive scent. In one embodiment, the perfume comprises at least one essential oil. In another embodiment, the perfume comprises an extract.

The term “fabric care composition” is used in the broadest to include any composition, in one embodiment a liquid composition, which imparts a fabric benefit, such as fabric cleaning, whiteness maintenance, softening, static control, absorbency, color care, or wrinkle control, and the like, to fabrics during the laundering process. In one embodiment, the fabric care composition is clear or translucent, with or without a dye. In another embodiment the fabric care composition is opaque, with without a dye. In one embodiment, the fabric care composition delivers perfume to treated laundry or fabric during the laundering process.

A. Fabric Conditioning Composition

In one embodiment, the fabric care composition comprises a fabric conditioning composition. By way of example, fabric conditioning compositions are described in U.S. Pat. Nos. 4,424,134; 4,767,547; 5,460,736; 5,545,340; 5,545,350; 5,562,849; 5,574,179; 5,874,396; 5,998,359; 6,020,304; 6,022,845; 6,083,899; 6,093,691; 6,103,678. In one embodiment, compositions of the present invention comprise a fabric softening active. In one embodiment, the fabric softening active is a quaternary ammonium compound.

In one embodiment, the fabric softening active comprises a cationic starch. Suitable cationic starches are described at U.S. Pat. Appl. Pub. US 2004/0204337, published Oct. 14, 2004, at paragraphs 16-29. Other suitable fabric softeners actives are also described in US 2004/0204337 at paragraphs 30-79.

In one embodiment, the fabric care composition is a “rinse added” composition, wherein the composition is added during a rinse cycle of an automatic washing machine. In another embodiment, the fabric care composition is a “wash-added” composition, wherein the composition is added at the initial, wash-cycle of an automatic washing machine.

B. Cleaning Composition

In another embodiment, the fabric care composition comprises a cleaning composition. The term “cleaning composition” is used herein in the broadest sense and includes heavy duty liquid laundry detergent compositions, light duty liquid laundry detergent compositions, laundry pretreaters, products for pre-soaking laundry, laundry additives and combinations thereof. Examples of cleaning compositions are described in U.S. Pat. Nos. 4,515,705; 4,537,706; 4,537,707; 4,550,862; 4,561,998; 4,597,898; 4,968,451; 5,565,145; 5,929,022; 6,294,514; and 6,376,445.

C. Combinations of Fabric Care Compositions

One aspect of the present invention provides instructions to the consumer to use fabric care compositions with the same, similar, or complimentary scent or scent identifiers in a regimen combination to achieve an enhanced scent experience. It is preferable in some instances to achieve a benefit of cleaning for example, with one composition and another benefit, such as softening, with a different composition. In this case it reinforces the consumers understanding and appreciation of the desired scent experience to instruct the consumer to use at least two products with the same, similar, or complimentary scent or scent identifiers in tandem.

In one embodiment, a kit is provided comprising an article comprising a fabric conditioning composition and instructions for use. In another embodiment, a kit is provided comprising at least two articles, wherein one article comprises a fabric conditioning composition and wherein another article comprises a cleaning composition, and instructions for use.

D. Perfume

Perfume is an essential ingredient of the fabric care compositions in the present invention. A “scent identifier” identifies the scent from the perfume. In one embodiment, the scent identifier comprises words, in another embodiment, less than three words.

In one embodiment, the perfume imparts a natural scent (irrespective of whether the composition of perfume is in fact from a natural source). In turn, the term “natural scent identifier,” as used herein, is scent identifier that communicates to the consumer a natural source that includes flowers fruits, nuts, berry, spices, and plants. For purposes of clarification, a “mountain spring,” although found in nature, does not impart a scent in nature (or at least one recognized by consumers) and thus is not considered a “natural scent identifier” as the term is herein defined. Surprisingly, the following natural scents and respective scent identifiers are preferred among consumers: vanilla, lavender, lilac, honeysuckle, rose, gardenia, jasmine, freesia, green apple, magnolia, lily of the valley, orchid, melon, violet, lily, pear, morning glory, chamomile, cucumber, almond, mandarin, mint, lemongrass, lime, snowflower, grapefruit, juniper, peony, sandalwood, tea tree, moonflower, lotus flower, iris, ylang ylang, cedarwood, ginger, green tea, patchouli, geranium, rosemary, tuberose, chrysanthemum, verbena, neroli, bergamot, thyme, marigold, bamboo, and vetyver, more preferably vanilla, lavender, lilac, honeysuckle, melon, gardenia, freesia, and rose. The perfume composition imparting a natural scent may be comprised of natural or non-natural perfume ingredients, or mixtures thereof.

In one embodiment, the perfume comprises an essential oil. Without wishing to be bound by theory, a perfume and a scent identifier comprising an essential oil is particularly useful for creating a scent experience because the scent identifier clearly communicates to the consumer what the scent experience will be and the essential oil in the composition reinforces the consumer's expectation. In one embodiment, the scent identifier comprises the term “essential oil.” In another embodiment, the scent identifier comprises the term “extract.”

One aspect of the invention provides a perfume that diffuses or imparts at least two scents but only two scent identifiers; alternatively the perfume diffuses or imparts at least three scents but only three scent identifiers. Without wishing to be bound theory, two scent identifiers describing two scents are more attractive to a larger consumer audience than one scent identifier describing one scent given the broadening range of appeal that two different scents offer and perhaps the synergy or complementary effect that two scents represent (or at least are perceived to represent); however, more than three scent identifiers describing more than three scents potentially confuses the consumer as to what the overall scent experience is thereby hindering the consumer's ability to identify the desired scent experience.

The fabric care composition comprises 0.05% to about 15%, preferably from about 0.1% to about 10%; more preferably from about 0.3% to about 6%, and even more preferably from about 0.5% to about 4%, by weight of the said fabric care composition of a perfume to provide an improved scent experience. An improved scent experience may be given by a perfume comprising one or more of the perfume ingredients types chosen from: (1) enduring perfume ingredients, to provide improved dry fabric odor; (2) blooming perfume ingredients, to provide increased impact during use; (3) low odor detection thresholds ingredients, to provide impactful neat product odor; (4) pro-perfume; (5) natural oil perfume ingredient; and (6) mixtures thereof. Some of the perfume ingredients belong to one or more of the perfume ingredient type categories described below and these are also acceptable for use in the present invention.

In one embodiment, the fabric care composition of the present invention comprises at least a natural oil perfume ingredient.

1. Enduring Perfume Ingredients

An enduring perfume ingredient is characterized by its boiling point (B.P.) and its octanol/water partitioning coefficient (P). The octanol/water partitioning coefficient of a perfume ingredient is the ratio between its equilibrium concentrations in octanol and in water. The perfume ingredients of this invention have a B.P., measured at the normal, standard pressure, of about 250° C. or higher, preferably more than about 260° C.; and an octanol/water partitioning coefficient P of about 1,000 or higher. Since the partitioning coefficients of the perfume ingredients of this invention have high values, they are more conveniently given in the form of their logarithm to the base 10, logP. Thus the enduring perfume ingredients of this invention have a calculated ClogP of about 3 or higher, preferably more than about 3.1, and even more preferably more than about 3.2. By way of example, enduring perfume ingredients are described in U.S. Pat. No. 6,491,728. In one embodiment of the present invention, the perfume comprises at least about 1%, preferably at least about 5%, more preferably at least about 10%, even more preferably at least about 25%, still more preferably at least about 50% even more preferably still at least about 70%, and most preferably at least about 75% of enduring perfume ingredients by weight of the perfume.

2. Blooming Perfume Ingredients

Blooming perfume ingredients are those having a boiling point (B.P.) equal to or lower than about 250° C., more preferably equal to or lower than about 250° C., wherein the B.P. is measured at the normal standard pressure. By way of example, blooming perfume ingredients are described at U.S. Pat. Nos. 6,194,362 and 6,143,707.

In one embodiment, the perfume of the present invention comprises at least about 3 different blooming perfume ingredients, preferably at least about 4 different blooming perfume ingredients, more preferably at least about 5 different blooming perfume ingredients, and even more preferably at least about 6 different blooming perfume ingredients.

The boiling points of many perfume ingredients are given in, e.g., “Perfume and Flavor Chemicals (Aroma Chemicals),” S. Arctander, published by the author, 1969. Other boiling point values can be obtained from different chemistry handbooks and databases, such as the Beilstein Handbook, Lange's Handbook of Chemistry, and the CRC Handbook of Chemistry and Physics.

In the perfume art, some materials having no odor or very faint odor are used as diluents or extenders. Non-limiting examples of these materials are dipropylene glycol, diethyl phthalate, triethyl citrate, isopropyl myristate, and benzyl benzoate. These materials are used for, e.g., diluting and stabilizing some other perfume ingredients. For purposes of this invention, these materials are not counted as a “blooming perfume ingredient.”

3. Pro-perfume

The perfume of the present invention can also include a pro-perfume. The term “pro-perfume” is herein defined to include: pro-fragrances, pro-perfumes, pro-accords, and mixtures thereof. Such pro-perfume may include acetal pro-perfumes, ketal pro-perfumes, ester pro-perfumes (e.g., digeranyl succinate), hydrolyzable inorganic-organic pro-perfumes, and mixtures thereof. These pro-perfumes are generally nonvolatile materials that release or convert to a perfume material, preferably a blooming perfume ingredient, as a result of, e.g., simple hydrolysis, or may be pH-change-triggered pro-perfumes (e.g. triggered by a pH drop) or may be enzymatically releasable pro-perfumes, or light-triggered pro-perfumes. The pro-perfumes of the present invention can exhibit varying release rates depending upon the pro-perfume chosen. Pro-perfumes are described in the following: U.S. Pat. No. 5,378,468; U.S. Pat. No. 5,626,852; U.S. Pat. No. 5,710,122; U.S. Pat. No. 5,716,918; U.S. Pat. No. 5,721,202; U.S. Pat. No. 5,744,435; U.S. Pat. No. 5,756,827; U.S. Pat. No. 5,830,835; U.S. Pat. No. 5,919,752; WO 00/02986 published Jan. 20, 2000; and WO 01/04248 published Jan. 18, 2001.

4. Low Odor Detection Threshold Perfume Ingredients

The perfume of the present invention may include low odor detection threshold perfume ingredients. As used herein, the “odor detection threshold” of a perfume ingredient is the lowest vapor concentration of that perfume ingredient which can be olfactorily detected. The odor detection threshold and some odor detection threshold values are discussed in, e.g., “Standardized Human Olfactory Thresholds”, M. Devos et al, IRL Press at Oxford University Press, 1990, and “Compilation of Odor and Taste Threshold Values Data”, F. A. Fazzalari, editor, ASTM Data Series DS 48A, American Society for Testing and Materials, 1978. Non-limiting examples of low odor detection threshold perfume ingredients are given in U.S. Patent Application Publication No. 2003/0104969 A1. In one embodiment the perfume comprises at least one low odor detection threshold perfume ingredient, more preferably at least two low odor detection ingredient.

5. Natural Perfume Oil Ingredients

A natural perfume oil ingredient is one that has a natural plant or animal source, preferably a plant source, or an oil that is a synthetic copy of a natural perfume oil. For the present invention, natural perfume oils derived from a natural source are preferred for authentically creating a scent that most closely matches verbal or visual scent descriptors. In another aspect of the present invention, synthetic copies of the natural scents are preferred when economizing the formula is a consideration. The perfume composition of fabric care products of the present invention preferably include at least one natural perfume oil ingredient from a natural source or a synthetic copy. Arctander, Steffen, “Perfume and Flavor Materials of Natural Origin,” 1960, Elizabeth, N.J. USA.

II. Container

Another aspect of the invention provides for a container. A suitable container for use in the present invention is any one that can contain a fabric care composition, preferably a liquid fabric care composition. Containers may be free standing bottles having an opening for pouring or dispensing the fabric care composition from the container. In one embodiment, the container is a water dissolvable unit dose (such as one make from polyvinyl alcohol film). Containers may have a variety of volumes permitting storage, by way of example, from a single dose to over 120 doses of the fabric care composition. Containers are typically made from plastic. In one embodiment, the container is made from plastic because plastic is economical and plastic is preferred over materials that shatter, e.g. glass, for storage in the consumer's home. Suitable plastics include, by way of example, high density polyethylene, polymethylmethacrylate, polycarbonate, diethyleneglycol bisarylcarbonate, polyethylene terephthalate, polyethylene naphthalate, polyvinyl chloride, polyurethane, epoxy resin, polyamide-based resins, low density polyethylene, styrene butadiene copolymers, acrylonitrile, acrylonitrile-butadiene copolymer, cellulose acetate butyrate and mixtures thereof.

In a preferred embodiment, clear or translucent plastics are used to form the container. Clear or translucent plastics have a light transmission of at least about 70%, more preferably at least about 80%, and even more preferably at least about 90%. The clear or translucent plastics of this invention can optionally be colored or tinted in such a manner that the light transmission of the plastic is preserve. Polyethylene terephthalate is a preferred plastic. Likewise the materials may be processed in single or multiple layers. Because a variety of different materials may be used in the construction of the containers of the present invention the materials selected will be based on the intended end use and characteristics required of such a container. A suitable container is described in U.S. Provisional Application Ser. No. 60/541,114, filed Feb. 2, 2004, entitled “CONTAINER HAVING A HELICAL GRIP,” to Brian Floyd, and the non-provisional application thereto; U.S. Pat. No. 4,550,862; and 4,981,239.

Without wishing to be bound by theory, clear or translucent container allows the consumer to see the color of the fabric care composition as the color provides an important visual descriptor to allow the consumer to “sample” the scent experience. In one embodiment, the container is tinted a color to enhance the visual descriptor function and thus the scent experience. An added benefit of a clear or translucent container is the consumer can readily identify the level of fabric softening composition contained therein. By readily observing the level drop to a low level with likely more readily prompt the consumer to go purchase more be running out.

In another embodiment, only a portion of the container is clear or translucent to allow the consumer to view the product. In one embodiment, the container, with respect to the total surface area, comprises at least 20%, preferably at least 50%, more preferably at least 70%, and most preferably at least about 85% clear or translucent material. In yet another embodiment, the portion of the container that is clear or translucent is tinted with a color. In still another embodiment, the fabric care composition itself is clear or translucent, wherein the composition may or may not be tinted with a dye.

III. Educational Scent Elements

As explained herein above, the scent experience of a fabric care article is important to the purchase decision of a consumer. Educational scent elements can provide the consumer with sufficient information to “sample” the scent experience such that the consumer can make an informed decision about the desirability of the scent experience at or before point of purchase without opening the packaging. Education scent element is chosen from a visual scent descriptor, narrative scent descriptor, or olfactory scent descriptor.

In one aspect of the invention, a fabric care article of the present invention comprises at least one, alternatively two, alternatively three educational elements.

A. Visual Scent Descriptor

The term “visual scent descriptor” is used herein in the broadest sense to include any illustration, painting, photograph, drawing, or picture that visually describes a scent or scent identifier; and optionally, elicits a certain emotional experience or mood.

Surprisingly, visual scent descriptors can clearly communicate a scent experience to the consumer thus allowing the consumer to “sample” the scent experience without opening packaging.

Non-limiting examples of visual scent descriptor include: a picture of a burning white candle with lavender spring to describe vanilla and lavender scents or scent identifiers, and optionally elicits a “warn or comforting” scent experience; a picture of a vine of morning glory and honeysuckle blowing in a sunny window frame with a wind chime to describe a morning glory and honeysuckle scents or scent identifiers, and optionally elicits a “bright or uplifting” scent experience; a picture of a water lily floating in a water pool to represent water lily and jasmine scents or scent identifiers, and optionally elicits a “crisp or refreshing” scent experience; and a picture of orange and magnolia blossoms to represent magnolia and orange scents or scent identifiers, and optionally elicits a “balancing and harmonizing” scent experience.

In one embodiment, the visual cue of the color of the fabric care composition and the tint of the container that comprises the fabric care composition may compliment the educational scent element function of a visual scent descriptor and thereby enhancing the overall scent experience for the user. Non-limiting examples of the following pairing of colors and tints with scents include the following: lavender for a vanilla and lavender scents or scent identifiers, blue for a morning glory and honeysuckle scents or scent identifiers, green for a water lily and jasmine scents or scent identifiers, and orange for magnolia and orange scents or scent identifiers.

B. Narrative Scent Descriptor

A “narrative scent descriptor” is used in the broadest sense to include a narrative that describes (either in writing or orally) a scent or scent identifier; and optionally, elicits a certain emotional experience or mood. In one embodiment, the narrative scent descriptor comprises at least five words; in another embodiment, at least ten words; in yet another embodiment, at least fifteen words. In another embodiment, the narrative scent descriptor comprises at least one sentence. In another embodiment, the narrative scent descriptor comprises at least two sentences.

For example, if the scents or scent identifiers are vanilla and lavender, a narrative scent descriptor may read as the following: “There aren't many times when I can relax and unwind. Those are the little moments I treasure for myself. Like each time I experience the aroma of rich vanilla and fresh lavender from Downy Simple Pleasures.™ It contains essentials oils for a warm and comforting scent experience.”

In another example, if the scents or scent identifiers are Morning Glory & Honeysuckle, the narrative scent descriptor may read as the following: “There's something about the day's first rays of sunshine that make me feel really alive, energized. I'm reminded of that feeling whenever I catch the scent of sweet honeysuckle and morning glory from Downy Simple Pleasures.™ It contains essential oils for a bright and uplifting scent experience.”

In yet another example, if the scents or scent identifiers are Water Lily and Jasmine, the narrative scent descriptor may read as the following: “To me nothing's as refreshing as water—whether it's a day near the ocean, a dip into a cool mountain stream, or the sound of a cascading waterfall. Whenever I catch the enticing essence of water lily and jasmine from Downy Simple Pleasures™ that feeling washes over me. It contains essential oils for a crisp and refreshing scent experience.”

In yet another example, if the scents or scent identifiers are Magnolia and Orange Blossom, the narrative scent descriptor may read as the following: “At times the pace of my life gets hectic, but I always try to keep my center grounded. Whenever I catch the scent of magnolia and orange blossom from Downy Simple Pleasures™, a sense of calm washes over me. It contains essential oils for a balancing and harmonizing scent experience.”

C. Olfactory Scent Descriptor

The term “olfactory scent descriptor” is used in the broadest sense to include any device that provides an olfactory sampling of a scent or scent identifier, of the fabric care composition, which is outside the sealed article or article package and that has a means for carrying the olfactory sampling for at least several days, preferably several weeks, and more preferably several months.

In one embodiment, the olfactory scent descriptor is operably affixed to the container of the present invention via a label. In another embodiment, the olfactory scent descriptor is typically a substrate composed of natural or artificial materials that is capable of emitting an olfactory scent to the consumer at all times or when activated by the consumer. Non-limiting examples of olfactory scent descriptors include: scent strips; “scratch and sniff” devices (including stickers); and plastic films that absorb perfume.

In another embodiment, the olfactory scent descriptor is a remote scent generator that is activated to provide a scent through electronic communication. The external device can be associated with the packaging at the point-of-purchase or disseminated through kiosks and media.

In yet another embodiment, the olfactory scent descriptor is a “scent releaser” placed near displays of the fabric care composition that can be activated by consumers to release an olfactory sample of the fabric care composition perfume. A non-limiting example of such a device is a trigger activated device releasing a scent.

In another aspect of the present invention the olfactory scent descriptor is a candle charged with an olfactory sample, of a fabric care composition perfume, that is released when the candle is used. In one embodiment, the candle may be packaged in a kit comprising the fabric care article of the present invention. In another embodiment, olfactory scent descriptor is a bath bead charged with an olfactory sample, of the fabric care composition perfume, that is released when the bead is used. In one embodiment, the bath bead may be packaged in a kit comprising the fabric care article. In yet another embodiment, the kit comprises instructions instructing the user that the candle or bath beads have the same scent as the fabric care composition.

IV. Methods of Disseminating Educational Scent Elements

A. Label

A label provides a convenient point-of-purchase site for educational scent elements. The term “label” is used herein in the broadest sense to include the tangible medium that educational scent elements are expressed including, by way of example, the placing of educational scent element directly on to a container (e.g., printing or molding), the printing of educational scent elements on a substrate wherein the substrate is placed on the outside surface of the container, or packaging such as boxes that enclose the container. In one embodiment, an olfactory scent descriptor may also be provided via a label (e.g., packaging). For example, the label itself may be scented, i.e., comprise the scent.

In one embodiment, the label is a clear substrate such that visual or verbal scent descriptors are printed on to the label and the bottle or fabric conditioning is substantially visible by the consumer through the label where the print of the narrative scent descriptor and visual scent descriptor are not printed. Without wishing to be bound by theory, a clear label may maximize the color of the composition or the tint of the container in communicating the scent experience to the consumer.

In another embodiment, the label has a background color to further communicate the scent experience to the user. For example, if the scents or scent identifiers are magnolia and orange, the label may have an orange background color to further communicate this scent experience to the user given that association of an orange color to orange the fruit or blossom and hence the orange scent.

In another embodiment, the educational scent elements and scent identifiers are printed directly on the container. In another embodiment, the educational scent elements are embossed on the container.

In one embodiment, the label is “shrink wrapped” on the container. In another embodiment, the label is adhered to the container by an adhesive.

B. Media

In one embodiment, educational scent elements are disseminated in electronic or print media. Electronic media encompasses internet, television, radio or any media broadcast through electronic means. Printed media encompasses all forms of visual or sensory media not transmitted via electronic means (e.g. magazines, billboards, store displays, etc.).

C. Kiosks And 3-D Displays

In another embodiment, educational scent elements are disseminated in Kiosks and 3-D displays. Kiosks and 3-D displays can be interactive and can incorporate media to provide multiple avenues for disseminating educational scent elements to the consumer simultaneously.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

Except as otherwise noted, the articles “a,” “an,” and “the” mean “one or more.”

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An article comprising:
a) a laundry cleaning composition comprising a perfume;
b) a container releasably containing the composition, wherein at least 20% of the total surface area of the container is clear or translucent;
c) at least one label attached to the container;
d) two natural scent identifiers located on the label;
e) a visual scent descriptor located on said at least one label visually describing the two scent identifiers;

2. The article of claim 1, wherein the natural scent identifiers are chosen from the following terms: vanilla, lavender, lilac, honeysuckle, rose, gardenia, jasmine, freesia, green apple, magnolia, lily of the valley, orchid, melon, violet, lily, pear, morning glory, chamomile, cucumber, almond, mandarin, mint, lemongrass, lime, snowflower, grapefruit, juniper, peony, sandalwood, tea tree, moonflower, lotus flower, iris, ylang ylang, cedarwood, ginger, green tea, patchouli, geranium, rosemary, tuberose, chrysanthemum, verbena, neroli, bergamot, thyme, marigold, bamboo, vetyver, orange, magnolia.

3. The article of claim 2, wherein the natural scent identifiers are chosen from the following: vanilla, lavender, morning glory, honeysuckle, water lily, jasmine, magnolia, and orange blossom.

4. The article of claim 3, wherein the natural scent identifiers are vanilla and lavender.

5. The article of claim 3, wherein the natural scent identifiers are morning glory and honeysuckle.

6. The article of claim 3, wherein the natural scent identifiers are water lily and jasmine.

7. The article of claim 3, wherein the natural scent identifiers are magnolia, and orange blossom.

8. The article of claim 3, wherein the narrative scent descriptor comprises at least two sentences.

9. The article of claim 3, wherein the narrative scent descriptor comprises the term “essential oil” or “extract.”

10. The article of claim 9, wherein the narrative scent descriptor comprises at least fifteen words.

11. The article of claim 8, wherein the fabric care composition comprises a liquid laundry detergent.

12. The article of claim 11, wherein at least 20% of total surface area of the container is clear or translucent.

13. The article of claim 1 wherein the perfume comprises at least at least about 75% of enduring perfume ingredients by weight of the perfume.

14. The article of claim 13, wherein the fabric care composition comprises a cationic starch.

15. The article of claim 14, wherein the container is clear or translucent.

16. The article of claim 15, wherein the container comprises polyethylene terephthalate.

17. A kit comprising a composition according to claim 1.

18. A method of cleaning a fabric comprising the step of contacting the fabric according to a composition according to claim 1.
